(19) United States
(12) Patent Application Publication
(10) Pub. No.: US 2024/0101102 A1
(43) Pub. Date: Mar. 28, 2024

(54) HYBRID VEHICLE CONTROL SYSTEM

(71) Applicant: SUBARU CORPORATION, Tokyo (JP)

(72) Inventor: Teppei WATABE, Tokyo (JP)

(73) Assignee: SUBARU CORPORATION, Tokyo (JP)

(21) Appl. No.: 18/367,750

(22) Filed: Sep. 13, 2023

(30) Foreign Application Priority Data
Sep. 26, 2022 (JP) 2022-152226

(51) Int. Cl. B60W 20/40; B60W 10/02; B60W 10/06; B60W 10/08

(52) U.S. Cl. CPC B60W 20/40; B60W 10/02; B60W 10/06; B60W 10/08; B60W 2510/0208; B60W 2510/083

(57) ABSTRACT

A hybrid vehicle control system configured to perform a control of a hybrid vehicle includes a transmission control unit, a motor control unit, and an engine and hybrid vehicle integrated control unit. The transmission control unit sends sudden deceleration determination permission information when a predetermined permission condition is satisfied at a time of electric vehicle traveling in which an engine is stopped, a clutch is disengaged, and the hybrid vehicle is driven by an electric motor. The clutch is interposed between the engine and a continuously variable transmission. The motor control unit performs a sudden deceleration determination of the hybrid vehicle when receiving the sudden deceleration determination permission information, and performs reduction of output torque of the electric motor when determining occurrence of sudden deceleration.

### CROSS-REFERENCE TO RELATED APPLICATION

The present application claims priority from Japanese Patent Application No. 2022-152226 filed on Sep. 26, 2022, the entire contents of which are hereby incorporated by reference.

### BACKGROUND

The disclosure relates to a hybrid vehicle control system.

Recently, a hybrid vehicle (a hybrid electric vehicle (HEV)) that is able to effectively improve fuel economy of a vehicle by combination use of an engine and an electric motor has been widely put into practical use.

For example, Japanese Unexamined Patent Application Publication (JP-A) No. 2013-133078 discloses a hybrid vehicle control apparatus including a hydraulic clutch, a continuously variable transmission, and a hydraulic pump. The hydraulic clutch is provided between an engine and a motor, and brings the engine and the motor into a coupled state or a decoupled state. The continuously variable transmission includes a primary pulley on a motor side and a secondary pulley on an axle side, and changes a shifting ratio. The hydraulic pump is coupled to each of an engine side of the hydraulic clutch and the motor side of the hydraulic clutch, and is driven by one of the engine and the motor that rotates faster.

In the hybrid vehicle control apparatus disclosed in JP-A No. 2013-133078, a hybrid electric vehicle control unit (HEVCU), a transmission control unit (TCU), an engine control unit (ECU), and a motor control unit (MCU) cooperate with each other, and when a vehicle speed abruptly decreases during motor-based traveling in which the engine is stopped and the hydraulic clutch is causing the decoupled state, the units start the engine while maintaining the decoupled state caused by the hydraulic clutch. This makes it possible to supply enough oil to the continuously variable transmission by starting the engine and driving the hydraulic pump even when sudden deceleration is caused (even when a motor speed decreases) during the motor-based traveling.

### SUMMARY

An aspect of the disclosure provides a hybrid vehicle control system configured to perform a control of a hybrid vehicle including an engine, an electric motor, a driving wheel, a clutch, and a continuously variable transmission. The hybrid vehicle control system includes a transmission control unit, a motor control unit, and an engine and hybrid vehicle integrated control unit. The transmission control unit is configured to control the continuously variable transmission. The continuously variable transmission includes a primary pulley, a secondary pulley, and a driving force transmission member. The primary pulley is coupled to each of the engine and the electric motor to allow for torque transmission between the primary pulley and each of the engine and the electric motor. The secondary pulley is coupled to the driving wheel to allow for torque transmission between the secondary pulley and the driving wheel. The driving force transmission member is wrapped around between the primary pulley and the secondary pulley. The motor control unit is configured to control the electric motor. The engine and hybrid vehicle integrated control unit is communicably coupled to each of the transmission control unit and the motor control unit via a communication network, and is configured to comprehensively control the engine and the hybrid vehicle. The transmission control unit is configured to send sudden deceleration determination permission information when a predetermined permission condition is satisfied at a time of electric vehicle traveling in which the engine is stopped, the clutch is disengaged, and the hybrid vehicle is driven by the electric motor. The clutch is interposed between the engine and the continuously variable transmission. The motor control unit is configured to perform a sudden deceleration determination of the hybrid vehicle when receiving the sudden deceleration determination permission information, and is configured to perform reduction of output torque of the electric motor when determining occurrence of sudden deceleration.

An aspect of the disclosure provides a hybrid vehicle control system configured to perform a control of a hybrid vehicle including an engine, an electric motor, a driving wheel, a clutch, and a continuously variable transmission. The hybrid vehicle control system includes circuitry. The circuitry is configured to control the continuously variable transmission. The continuously variable transmission includes a primary pulley, a secondary pulley, and a driving force transmission member. The primary pulley is coupled to each of the engine and the electric motor to allow for torque transmission between the primary pulley and each of the engine and the electric motor. The secondary pulley is coupled to the driving wheel to allow for torque transmission between the secondary pulley and the driving wheel. The driving force transmission member is wrapped around between the primary pulley and the secondary pulley. The circuitry is configured to control the electric motor. The circuitry is configured to comprehensively control the engine and the hybrid vehicle. The circuitry is configured to send sudden deceleration determination permission information when a predetermined permission condition is satisfied at a time of electric vehicle traveling in which the engine is stopped, the clutch is disengaged, and the hybrid vehicle is driven by the electric motor. The clutch is interposed between the engine and the continuously variable transmission. The circuitry is configured to perform a sudden deceleration determination of the hybrid vehicle when receiving the sudden deceleration determination permission information, and perform reduction of output torque of the electric motor when determining occurrence of sudden deceleration.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a configuration of a hybrid vehicle control system according to one example embodiment of the disclosure and of a portion of a hybrid vehicle to which the hybrid vehicle control system is applied.

FIG. 2 is a flowchart illustrating a process procedure of a sudden deceleration chain slip prevention control to be performed by the hybrid vehicle control system according to the example embodiment.

FIG. 3 includes timing charts illustrating respective examples of changes in motor torque, primary pulley shaft rotational speed, and actual line pressure at a time of sudden deceleration during electric vehicle (EV) traveling, caused by each of the hybrid vehicle control system according to the example embodiment and a hybrid vehicle control system (an existing hybrid vehicle control system) according to a comparative example.

### DETAILED DESCRIPTION

According to a technique disclosed in JP-A No. 2013-133078, when sudden deceleration is caused during EV traveling, an engine is restarted and a hydraulic pump is driven. A hydraulic pressure is thus applied to a continuously variable transmission. However, for example, a delay in operation can delay an increase in hydraulic pressure caused by restarting of the engine with respect to a decrease in hydraulic pressure due to a decrease in rotational speed of an oil pump accompanying the sudden deceleration. This can cause a slip of a chain or the like (a driving force transmission member) of the continuously variable transmission (a variator). The delay in operation may be, for example: a delay in sensing of a vehicle speed, etc.; a delay in communication between control units; a delay in a process such as a sudden deceleration determination; and a delay in a process from determination of occurrence of the sudden deceleration to cranking and restarting of the engine, and to driving of an oil pump and increasing of a hydraulic pressure.

It is desirable to provide a hybrid vehicle control system that makes it possible to more reliably prevent a slip of a driving force transmission member, such as a chain, of a continuously variable transmission also when a hybrid vehicle suddenly decelerates at a time of EV traveling. The EV traveling is traveling in which an engine is stopped, a clutch interposed between the engine and the continuously variable transmission is disengaged, and the hybrid vehicle is driven by an electric motor. The hybrid vehicle control system includes a transmission control unit, a motor control unit, and an engine and hybrid vehicle integrated control unit. The transmission control unit controls the continuously variable transmission. The continuously variable transmission includes a primary pulley, a secondary pulley, and a driving force transmission member such as the chain. The primary pulley is coupled to each of the engine and the electric motor to allow for torque transmission between the primary pulley and each of the engine and the electric motor. The secondary pulley is coupled to the driving wheel to allow for torque transmission between the secondary pulley and the driving wheel. The driving force transmission member is wrapped around between the primary pulley and the secondary pulley. The motor control unit controls the electric motor. The engine and hybrid vehicle integrated control unit is communicably coupled to each of the transmission control unit and the motor control unit via a communication network, and comprehensively controls the engine and the hybrid vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

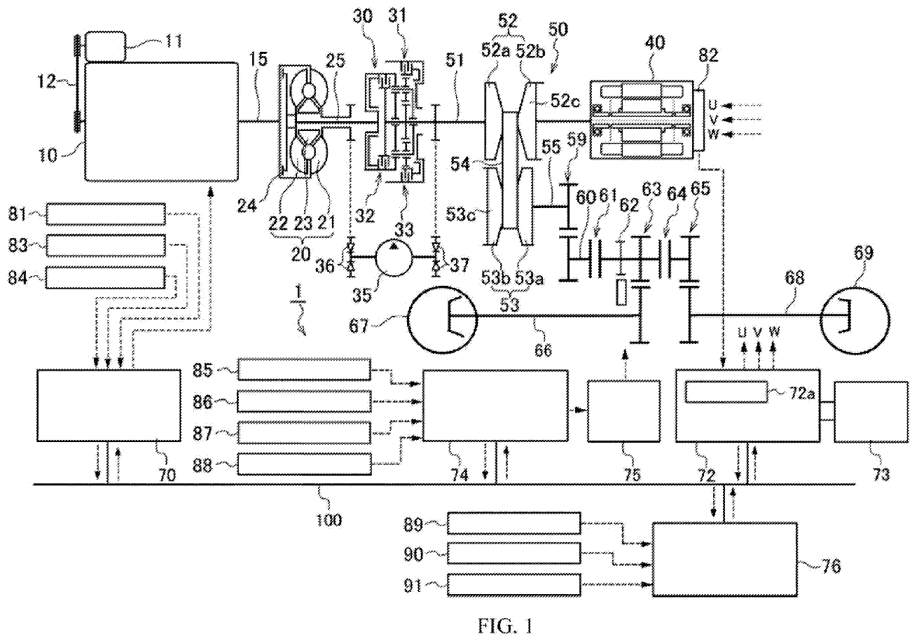

First, with reference to FIG. 1, a description is provided of a configuration of a control system 1 for a hybrid vehicle according to an example embodiment, and a configuration of a portion of a hybrid vehicle to which the control system 1 is applied. FIG. 1 illustrates the configuration of the control system 1 for a hybrid vehicle, and the configuration of a portion of the hybrid vehicle to which the control system 1 is applied.

An engine 10 may be of any type, and may be, for example, a horizontally opposed direct-injection four-cylinder gasoline engine. In the engine 10, intake air from an unillustrated air cleaner may be throttled by an electronically controlled throttle valve provided in an intake pipe, may pass through an intake manifold, and may be taken into cylinders each included in the engine 10. An amount of the intake air from the air cleaner may be detected by an air flow meter 83. Further, a throttle angle sensor may be disposed at the throttle valve. The throttle angle sensor may detect an opening degree of the throttle valve. An injector may be attached to each of the cylinders. The injector may inject fuel. Further, an ignition plug and an igniter-built-in coil may be attached to each of the cylinders. The ignition plug may ignite an air-fuel mixture. The igniter-built-in coil may apply high voltage to the ignition plug. In each of the cylinders of the engine 10, the air-fuel mixture of the intake air and the fuel injected by the injector may be ignited by the ignition plug and combusted. The exhaust gas generated by the combustion may be discharged through an exhaust pipe.

In addition to the air flow meter 83 and the throttle angle sensor described above, a cam angle sensor may be attached near a camshaft of the engine 10. The cam angle sensor may perform cylinder determination of the engine 10. In addition, a crank angle sensor 84 may be attached near a crankshaft 15 of the engine 10. The crank angle sensor 84 may detect a rotational position (a rotational speed) of the crankshaft 15. These sensors may be coupled to an engine and hybrid vehicle integrated control unit 70 which will be described later. Hereinafter, the engine and hybrid vehicle integrated control unit may be referred to as an “ENG-HEV integrated CU”. In addition, various other sensors may be coupled to the ENG-HEV integrated CU 70. Non-limiting examples of such various other sensors may include a coolant temperature sensor that detects a temperature of a coolant of the engine 10.

An integrated starter generator (ISG) 11 may be attached to one end (on a vehicle front side) of the crankshaft 15 of the engine 10. A belt 12 may be wrapped around between an output shaft of the ISG 11 and the crankshaft 15. The belt 12 may transmit driving force. This may allow the ISG 11 to transmit power between the ISG 11 and the crankshaft 15 of the engine 10. The ISG 11 may operate as a starter motor that starts the engine 10 and also as a generator.

A continuously variable transmission 50 may be coupled to another end (on a vehicle rear side) of the crankshaft 15 of the engine 10 via a torque converter 20 and a forward-backward travel changeover mechanism 30. The torque converter 20 may serve as both a clutch and a torque multiplier. The continuously variable transmission 50 may convert driving force from the engine 10, and may output the converted driving force.

The torque converter 20 may include, for example but not limited to, a pump impeller 21, a turbine runner 22, and a stator 23. The pump impeller 21 may be coupled to the crankshaft 15. The pump impeller 21 may generate an oil flow. The turbine runner 22 may be opposed to the pump impeller 21. The turbine runner 22 may receive power of the engine 10 via the oil, and may drive a turbine shaft 25. The stator 23 may be positioned between the pump impeller 21 and the turbine runner 22. The stator 23 may alter the oil flow exhausted or returned from the turbine runner 22, and may return the oil flow to the pump impeller 21, thereby allowing for torque multiplication.

The torque converter 20 may further include a lock-up clutch 24. The lock-up clutch 24 may bring an input and an output into a directly coupled state. When the lock-up clutch 24 is in a disengaged state (a non-lock-up state), the torque converter 20 may perform torque multiplication on driving force of the engine 10, and may transmit the driving force to the continuously variable transmission 50. When the lock-up clutch 24 is in an engaged state (a lock-up state), the torque converter 20 may directly transmit the driving force of the engine 10 to the continuously variable transmission 50. A rotational speed (a turbine rotational speed) of the turbine runner 22 included in the torque converter 20 may be detected by a turbine rotation sensor 87. The detected turbine rotational speed may be supplied to a transmission control unit 74 which will be described later. Hereinafter, the transmission control unit may be referred to as a “TCU”.

The forward-backward travel changeover mechanism 30 may perform switching between forward rotation and reverse rotation of a driving wheel, i.e., switching between forward traveling and backward traveling of a vehicle. The forward-backward travel changeover mechanism 30 may include, for example but not limited to, a planetary gear train 31 of a double pinion type, a forward clutch 32, and a reverse brake 33. The forward-backward travel changeover mechanism 30 may be configured to switch a transmission path of engine driving force by controlling respective states of the forward clutch 32 and the reverse brake 33.

For example, when a D range (a forward traveling range) is selected, the forward clutch 32 may be engaged and the reverse brake 33 may be disengaged. This may allow rotation of the turbine shaft 25 to be transmitted to a primary shaft 51 as it is, and may thereby allow the vehicle to travel forward. The primary shaft 51 will be described later. When an R range (a backward traveling range) is selected, the forward clutch 32 may be disengaged and the reverse brake 33 may be engaged. This may cause the planetary gear train 31 to operate, and may thereby reverse a rotation direction of the primary shaft 51, allowing the vehicle to travel backward. When an N range or a P range is selected, the forward clutch 32 and the reverse brake 33 may be disengaged. This may separate the turbine shaft 25 and the primary shaft 51 from each other, that is, this may block the transmission of the engine driving force, causing the forward-backward travel changeover mechanism 30 to be in a neutral state in which no power is transmitted to the primary shaft 51.

An operation of each of the forward clutch 32 and the reverse brake 33, i.e., whether each of the forward clutch 32 and the reverse brake 33 is engaged or disengaged, may be controlled by the TCU 74 to be described later and a control valve 75. During EV traveling in which the vehicle is driven simply by the electric motor 40, the forward clutch 32 and the reverse brake 33 may be disengaged, and the engine 10 may thereby be decoupled. In one embodiment, the forward clutch 32 and the reverse brake 33 may serve as a “clutch”.

The continuously variable transmission 50 may include the primary shaft 51 and a secondary shaft 55. The primary shaft 51 may be coupled to the turbine shaft 25 of the torque converter 20 via the forward-backward travel changeover mechanism 30. The secondary shaft 55 may be disposed in parallel with the primary shaft 51.

The primary shaft 51 may be provided with a primary pulley 52. The primary pulley 52 may include a fixed sheave 52a and a moving sheave 52b. The fixed sheave 52a may be coupled to the primary shaft 51. The moving sheave 52b may be opposed to the fixed sheave 52a, and may be slidably attached in a shaft direction of the primary shaft 51. The primary pulley 52 may be configured to change a cone surface spacing between the fixed sheave 52a and the moving sheave 52b, i.e., a pulley groove width. The secondary shaft 55 may be provided with a secondary pulley 53. The secondary pulley 53 may include a fixed sheave 53a and a moving sheave 53b. The fixed sheave 53a may be coupled to the secondary shaft 55. The moving sheave 53b may be opposed to the fixed sheave 53a, and may be slidably attached in a shaft direction of the secondary shaft 55. The secondary pulley 53 may be configured to change a pulley groove width.

A chain 54 may be wrapped around between the primary pulley 52 and the secondary pulley 53. The chain 54 may transmit driving force. In one embodiment, the chain 54 may serve as a “driving force transmission member”. A shifting ratio may be continuously varied by varying the groove width of each of the primary pulley 52 and the secondary pulley 53 and thereby varying a ratio between a diameter of the chain 54 wrapped around the primary pulley 52 and a diameter of the chain 54 wrapped around the secondary pulley 53, i.e., a pully ratio. Here, where the diameter of the chain 54 wrapped around the primary pulley 52 is Rp, and the diameter of the chain 54 wrapped around the secondary pulley 53 is Rs, a shifting ratio i may be represented by the following expression: i=Rs/Rp. The shifting ratio i may thus be determined by dividing a primary pully rotational speed Np by a secondary pully rotational speed Ns (i=Np/Ns).

An oil pressure chamber 52c may be provided on a back surface side of the moving sheave 52b of the primary pulley 52. An oil pressure chamber 53c may be provided on a back surface side of the moving sheave 53b of the secondary pulley 53. The groove width of the primary pulley 52 may be set and changed by adjusting a primary oil pressure introduced to the oil pressure chamber 52c of the primary pulley 52. The groove width of the secondary pulley 53 may be set and changed by adjusting a secondary oil pressure introduced to the oil pressure chamber 53c of the secondary pulley 53.

The electric motor 40 may be coupled to the primary shaft 51 of the continuously variable transmission 50 to allow for torque transmission. The electric motor 40 may be, for example, a three-phase alternating-current synchronized motor. In the example embodiment, an electric motor including a permanent magnet as a rotator and a coil as a stator may be employed as the electric motor 40. The electric motor 40 may operate, for example but not limited to, as a driving force source that drives the vehicle. The electric motor 40 may be a so-called motor generator that serves as a generator, for example, upon regeneration. In one example, the electric motor 40 may include a coil as the rotator and a permanent magnet as the stator. In one example, an alternating-current induction motor, a direct-current motor, or any other kind of motor may be used as the electric motor 40, instead of the alternating-current synchronized motor.

The continuously variable transmission 50 may be provided with an oil pump 35. The oil pump 35 may pump oil to be used in the continuously variable transmission 50, the forward-backward travel changeover mechanism 30, the electric motor 40, and any other component. The oil pump 35 may suck the oil stored in an unillustrated oil pan, boost a pressure, and pump the oil to the continuously variable transmission 50, the forward-backward travel changeover mechanism 30, the electric motor 40, and any other component. For example, a trochoid pump, a vane pump, or any other pump may be used as the oil pump 35. The oil pump 35 may have a drive shaft coupled to each of the pump impeller 21 (the crankshaft 15) and the primary shaft 51 via, for example, a chain or any other member to allow for torque transmission. That is, the oil pump 35 may be drivable by each of the engine 10 and the electric motor 40.

For example, the drive shaft of the oil pump 35 may be coupled to the engine 10 via a first one-way clutch 36 to allow for torque transmission, and may be coupled to the electric motor 40 via a second one-way clutch 37 to allow for torque transmission. The oil pump 35 may therefore be driven by one of the engine 10 and the electric motor 40 having a higher rotational speed.

The secondary shaft 55 of the continuously variable transmission 50 may be coupled to a counter shaft 60 via a reduction gear (a secondary reduction gear) 59. The reduction gear 59 may include a pair of gears, i.e., a reduction drive gear and a reduction driven gear. Driving force converted by the continuously variable transmission 50 may be transmitted to the counter shaft 60 via the reduction gear 59. An output clutch 61 and a parking gear 62 may be attached to the counter shaft 60. The parking gear 62 may be included in a parking mechanism.

The output clutch 61 may be provided between the secondary shaft 55 of the continuously variable transmission 50 and the driving wheel. The output clutch 61 may interrupt or allow for torque transmission between the continuously variable transmission 50 (the engine 10 and the electric motor 40) and the driving wheel. For example, when the electric motor 40 is rotated by the engine 10 to generate power while the vehicle is stopped, the output clutch 61 may be disengaged to decouple the engine 10 and the electric motor 40 from a wheel side. The output clutch 61 may therefore be engaged otherwise (e.g., while the vehicle is traveling). A control (engagement and disengagement) of the output clutch 61 may be performed by the TCU 74 which will be described later. Note that the output clutch 61 may be omitted if the provided configuration (specification) does not involve power generation at a time when the vehicle is stopped.

The counter shaft 60 may be coupled to a front drive shaft 66 via a counter gear 63. The counter gear 63 may include a pair of gears, i.e., a counter drive gear and a counter driven gear. Driving force transmitted to the counter shaft 60 may be transmitted to a front differential 67 via the counter gear 63 and the front drive shaft 66. The front differential 67 may be, for example, a bevel gear differential. Driving force from the front differential 67 may be transmitted to a left front wheel via a left front wheel drive shaft, and may be transmitted to a right front wheel via a right front wheel drive shaft.

A transfer clutch 64 may be interposed after the counter gear 63 (the counter drive gear) on the counter shaft 60 described above. The transfer clutch 64 may adjust driving force transmitted to a rear differential 69. Engagement force of the transfer clutch 64, that is, a ratio of torque distributed to rear wheels, may be controlled in accordance with, for example but not limited to, a driving state of four wheels, engine torque, or any other factor. The driving state of the four wheels may be, for example but not limited to, a slipping state of front wheels. The driving force transmitted to the counter shaft 60 may thus be distributed in accordance with the engagement force of the transfer clutch 64, and may also be transmitted to a rear wheel side.

For example, a rear end of the counter shaft 60 may be coupled to a propeller shaft 68 via a transfer gear 65. The propeller shaft 68 may extend to a rear side of the vehicle. The transfer gear 65 may include a pair of gears, i.e., a transfer drive gear and a transfer driven gear. Driving force transmitted to the counter shaft 60 and adjusted or distributed by the transfer clutch 64 may be transmitted from the transfer gear 65 (the transfer driven gear) to the rear differential 69 via the propeller shaft 68.

A left rear wheel drive shaft and a right rear wheel drive shaft may be coupled to the rear differential 69. Driving force from the rear differential 69 may be transmitted to a left rear wheel via the left rear wheel drive shaft, and may be transmitted to a right rear wheel via a right rear wheel drive shaft.

With the above-described configuration, the hybrid vehicle may be able to drive the wheels or the vehicle by two kinds of power, i.e., the power of the engine 10 and the power of the electric motor 40. The hybrid vehicle may also be able to perform deceleration regeneration and power generation with use of the electric motor 40. In addition, the hybrid vehicle may be able to perform EV traveling in which the vehicle is driven simply by the electric motor 40.

The engine 10 and the electric motor 40 that are the driving force sources of the vehicle, and the continuously variable transmission 50 may be generally controlled by a control system including, for example but not limited to, the ENG-HEV integrated CU 70, a motor control unit 72, the TCU74, and a vehicle dynamics control unit 76. Hereinafter, the motor control unit may be referred to as an “MCU”, and the vehicle dynamics control unit may be referred to as a “VDCU”.

The ENG-HEV integrated CU 70, the MCU 72, the TCU 74, and the VDCU 76 may each include a microprocessor, an electrically erasable programmable read-only memory (EEPROM), a random access memory (RAM), a backup RAM, an input and output interface (I/F), and any other component. The microprocessor may perform a calculation. The EEPROM may hold, for example but not limited to, a program that allows the microprocessor to execute each process. The RAM may hold various kinds of data including, without limitation, a calculation result. The backup RAM may hold contents stored in the RAM.

The ENG-HEV integrated CU 70, the MCU 72, the TCU 74, and the VDCU 76 may be communicably coupled to each other via a controller area network (CAN) 100. In one embodiment, the CAN 100 may serve as a “communication network”.

For example, various sensors may be coupled to the ENG-HEV integrated CU 70. The various sensors may include, for example but not limited to, an accelerator pedal sensor 81. The accelerator pedal sensor 81 may detect a depressed amount of an accelerator pedal, that is, an operation amount of the accelerator pedal. The ENG-HEV integrated CU 70 may receive various kinds of information from units including, without limitation, the MCU 72, the TCU 74, the VDCU 76 via the CAN 100. The various kinds of information may include, for example but not limited to, a primary pulley rotational speed, a secondary pulley rotational speed, an operation amount of a brake, a steering angle of a steering wheel, a yaw rate, and a vehicle speed.

The ENG-HEV integrated CU 70 may comprehensively (generally) control driving of the engine 10, the electric motor 40, and the continuously variable transmission 50 based on the various kinds of acquired information. For example, the ENG-HEV integrated CU 70 may determine a requested output of the engine 10, a torque command value of the electric motor 40, and a target shifting ratio of the continuously variable transmission 50 based on the various kinds of information including, without limitation, the operation amount of the accelerator pedal (requested driving force from a driver who drives the vehicle), an engine speed, a motor speed, the primary pulley rotational speed, the secondary pulley rotational speed, a driving state of the vehicle (e.g., the vehicle speed, the steering angle, etc.), and a state of charge (SOC) of a high voltage battery 73. The ENG-HEV integrated CU 70 may output the determined torque command value, the determined target shifting ratio, etc. via the CAN 100.

The ENG-HEV integrated CU 70 may determine the cylinder based on an output of the cam angle sensor described above, and may determine the engine speed (rotational speed) based on a change in the rotational position of the crankshaft 15. The change in the rotational position of the crankshaft 15 may be detected based on an output of the crank angle sensor 84. In addition, the ENG-HEV integrated CU 70 may acquire various kinds of information based on detection signals supplied from the various sensors described above. Non-limiting examples of the various kinds of information may include an intake air amount, the operation amount of the accelerator pedal, an air-fuel ratio of the air-fuel mixture, and a water temperature. Based on the various kinds of acquired information and a requested output, the ENG-HEV integrated CU 70 may control, for example but not limited to, an injection quantity, an ignition timing, and various devices including, without limitation, an electronically controlled throttle valve, thereby controlling the engine 10.

In addition, the ENG-HEV integrated CU 70 may calculate engine actual torque (output torque) of the engine 10 based on, for example but not limited to, the intake air amount detected by the air flow meter 83 and the engine speed. The ENG-HEV integrated CU 70 may transmit the pieces of information including, without limitation, the engine speed (rotational speed) and the engine actual torque to a unit such as the TCU 74 via the CAN 100.

For example, various sensors may be coupled to the MCU 72. Non-limiting examples of the various sensors may include a resolver 82 that detects a rotational position (rotational speed) of the electric motor 40. In one embodiment, the resolver 82 may correspond to a “motor speed sensor”. The MCU 72 may drive the electric motor 40 via an inverter 72a based on the torque command value supplied from the ENG-HEV integrated CU 70. Here, the inverter 72a may convert the direct-current power of the high voltage battery 73 into three-phase alternating-current power, and may supply the converted power to the electric motor 40. For example, upon regeneration, the inverter 72a may convert the alternating-current voltage generated by the electric motor 40 into a direct-current voltage to charge the high voltage battery 73.

When receiving a sudden deceleration determination permission flag, the MCU 72 may execute a sudden deceleration determination of the vehicle, that is, may determine whether the vehicle is suddenly decelerating. When determining occurrence of sudden deceleration, the MCU 72 may perform reduction of the output torque of the electric motor 40. For example, the MCU 72 may reduce the output torque of the electric motor 40 to 0 Nm. Details will be described later.

Devices including, without limitation, a brake switch 89 and a brake fluid pressure sensor 90 may be coupled to the VDCU 76. The brake switch 89 may detect whether a brake pedal is depressed. The brake fluid pressure sensor 90 may detect a master cylinder pressure (a brake oil pressure) of a brake actuator. A device such as a wheel speed sensor 91 may also be coupled to the VDCU 76. The wheel speed sensor 91 may detect a rotational speed of each of the wheels of the vehicle, i.e., the vehicle speed. For example, a magnetic pickup may be used as the wheel speed sensor 91.

The VDCU 76 may perform braking of the vehicle by driving the brake actuator in accordance with an operation amount (a depressed amount) of the brake pedal. In addition, the VDCU 76 may secure vehicle stability upon turning by suppressing a lateral slip. To suppress the lateral slip, the VDCU 76 may detect vehicle behavior with use of the various sensors, and thereby perform automatic-pressurization brake control and a torque control of components including the engine 10. The above-described various sensors may include, for example, the wheel speed sensor 91, a steering angle sensor, an acceleration sensor, and a yaw rate sensor. In addition, the VDCU 76 may perform both an antilock brake system (ABS) operation and a traction control system (TCS) operation. The ABS operation may prevent wheel lock and appropriately maintain a slip ratio of each of the wheels. This may secure direction stability and steering property upon braking, and may achieve appropriate braking force. The wheel lock may occur, for example, when braking is performed suddenly or on a slippery road surface. The TCS operation may suppress idling of the driving wheel to secure vehicle stability and acceleration property upon starting or acceleration. The idling of the driving wheel may be caused, for example, by a slippery road surface or excessively great driving force.

The VDCU 76 may transmit information including, without limitation, the detected braking information (braking operation information) and the wheel speed (the vehicle speed) to units including, without limitation, the TCU 74 and the ENG-HEV integrated CU 70 via the CAN 100. Non-limiting examples of the detected braking information may include braking information regarding the brake switch 89 and the brake fluid pressure.

Sensors including, without limitation, a primary pulley rotation sensor 85 and a secondary pulley rotation sensor 86 may be coupled to the TCU 74. The primary pulley rotation sensor 85 may detect a rotational speed of the primary pulley 52. The secondary pulley rotation sensor 86 may detect a rotational speed of the secondary pulley 53. The rotational speed of the secondary pulley 53 may correspond to the vehicle speed. In addition, sensors including, without limitation, the turbine rotation sensor 87 and an output clutch rotation sensor 88 may also be coupled to the TCU 74.

The TCU 74 may receive information including, without limitation, the engine actual torque, motor actual torque, and the operation amount of the accelerator pedal from the ENG-HEV integrated CU 70 via the CAN 100. The TCU 74 may receive information including, without limitation, the vehicle speed and braking operation information from the VDCU 76 via the CAN 100.

The TCU 74 may continuously change the shifting ratio of the continuously variable transmission 50 based on the various pieces of acquired information (the driving state of the vehicle) and the target shifting ratio from the ENG-HEV integrated CU 70.

Upon continuously changing the shifting ratio of the continuously variable transmission 50, the TCU 74 may control driving of a solenoid valve included in the above-described control valve 75 to adjust an oil pressure supplied to the oil pressure chamber 52c of the primary pulley 52 and the oil pressure chamber 53c of the secondary pulley 53, thereby changing the shifting ratio of the continuously variable transmission 50. Further, the TCU 74 may control driving of a forward clutch solenoid included in the above-described control valve 75 to adjust an amount of oil supplied to and discharged from the forward clutch 32, thereby engaging and disengaging the forward clutch 32. In a similar manner, the TCU 74 may control driving of a reverse brake solenoid included in the above-described control valve 75 to adjust an amount of oil supplied to and discharged from the reverse brake 33, thereby engaging and disengaging the reverse brake 33.

In addition, the TCU 74 may control driving of a solenoid valve included in the above-described control valve 75 to adjust an oil pressure supplied to the transfer clutch 64 (that is, to adjust engagement force), thereby adjusting a distribution ratio of driving force transmitted to the rear wheels. Further, the TCU 74 may control driving of a solenoid valve included in the above-described control valve 75, thereby controlling engagement and disengagement of the output clutch 61.

For example, the ENG-HEV integrated CU 70, the MCU 72, and the TCU 74 may cooperate and serve to more reliably prevent a slip of the chain 54 (the driving force transmission member) of the continuously variable transmission 50 (the variator) also when the vehicle suddenly decelerates at the time of the EV traveling in which the engine 10 is stopped, the forward clutch 32 and the reverse brake 33 interposed between the engine 10 and the continuously variable transmission 50 are disengaged, and the vehicle is driven simply by the electric motor 40, that is, when sudden deceleration in which tires are locked on a road surface having a low coefficient of friction occurs in a situation where the oil pressure of the continuously variable transmission 50 is secured simply by the mechanical oil pump 35 during the EV traveling. The ENG-HEV integrated CU 70, the MCU 72, and the TCU 74 may perform such an operation by microprocessors executing a program stored in a storage such as the EEPROM.

The TCU 74 may send or transmit the sudden deceleration determination permission flag via the CAN 100 when a predetermined permission condition is satisfied at the time of the EV traveling in which the engine 10 is stopped, the forward clutch 32 and the reverse brake 33 are disengaged, and the vehicle is driven simply by the electric motor 40. The predetermined permission condition may be a condition in which the chain slips upon occurrence of sudden deceleration, which will be described in detail later. In one embodiment, the sudden deceleration determination permission flag may serve as “sudden deceleration determination permission information”.

When receiving the sudden deceleration determination permission flag via the CAN 100, the MCU 72 may perform the sudden deceleration determination of the vehicle, that is, may determine whether the vehicle is suddenly decelerating. If the MCU 72 determines occurrence of the sudden deceleration, the MCU 72 may reduce the output torque of the electric motor 40. For example, the MCU 72 may reduce the output torque of the electric motor 40 to 0 Nm.

A processing cycle (a calculation cycle) of the MCU 72 may be, for example, 1 msec. A processing cycle (a calculation cycle) of the TCU 74 may be, for example, 10 msec. That is, the MCU 72 may have a shorter processing cycle (calculation cycle) for the sudden deceleration determination of the vehicle than the TCU 74.

In addition, as described above, the resolver 82 may be coupled to the MCU 72. The resolver 82 may have a higher resolution and a shorter sensing cycle than the vehicle speed sensor (the magnetic pickup) that detects the vehicle speed. The MCU 72 may perform the sudden deceleration determination of the vehicle with use of a value (the motor speed) detected by the resolver 82.

When the sudden deceleration determination permission flag is sent or transmitted from the TCU 74, the ENG-HEV integrated CU 70 may relay the sudden deceleration determination permission flag to the MCU 72. That is, the ENG-HEV integrated CU 70 may serve simply as a gateway.

In addition, the MCU 72 may stop the reduction of the output torque of the electric motor 40 (return to a normal control) when a predetermined period of time elapses after starting the reduction of the output torque of the electric motor 40 (to 0 Nm). The predetermined period of time may be, for example, 0.5 sec. Note that the predetermined period of time may be set taking into consideration, for example but not limited to, a period of time from a timing at which the engine 10 is restarted to a timing at which the oil pump 35 is driven by the engine 10.

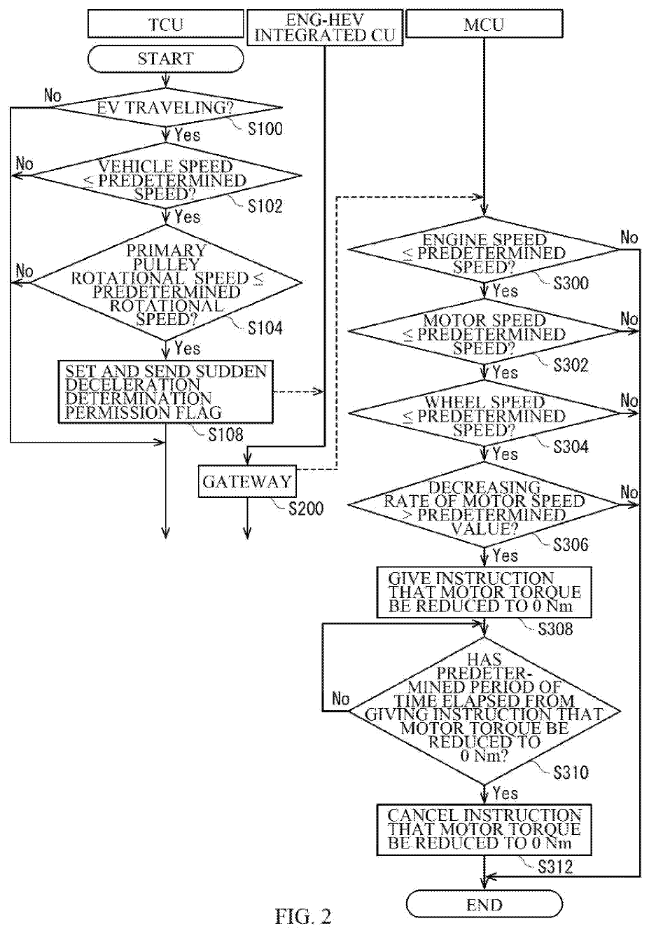

Next, an operation of the control system 1 for a hybrid vehicle will be described with reference to FIG. 2. FIG. 2 is a flowchart illustrating a process procedure of a sudden deceleration chain slip prevention control to be performed by the control system 1 for a hybrid vehicle. This process may be repeatedly executed at predetermined timings by each of the ENG-HEV integrated CU 70, the MCU 72, and the TCU 74. The predetermined timings may be, for example, every 1 msec for the MCU 72, and every 10 msec for the TCU 74.

In step S100, the TCU 74 may determine whether the EV traveling is being performed. The EV traveling may be traveling in which the engine 10 is stopped, the forward clutch 32 and the reverse brake 33 are disengaged, and the vehicle is driven simply by the electric motor 40. If the EV traveling is being performed (step S100: Yes), the process may proceed to step S102. If the EV traveling is not being performed (step S100: No), the sudden deceleration determination permission flag may be cleared, and the operation may once exit the process.

In step S102, a determination may be performed as to whether the vehicle speed is lower than or equal to a predetermined speed. If the vehicle speed is lower than or equal to the predetermined speed (step S102: Yes), the process may proceed to step S104. If the vehicle speed is not lower than or equal to the predetermined speed (step S102: No), the sudden deceleration determination permission flag may be cleared, and the operation may once exit the process.

In step S104, a determination may be performed as to whether the primary pulley rotational speed is lower than or equal to a predetermined rotational speed. If the primary pulley rotational speed is lower than or equal to the predetermined rotational speed (step S104: Yes), the process may proceed to step S108. If the primary pulley rotational speed is not lower than or equal to the predetermined rotational speed (step S104: No), the sudden deceleration determination permission flag may be cleared, and the operation may once exit the process.

In step S108, the sudden deceleration determination permission flag may be set. Thereafter, the sudden deceleration determination permission flag may be sent or transmitted via the CAN 100.

When the sudden deceleration determination permission flag is sent or transmitted, in step S200, the ENG-HEV integrated CU 70 may relay the sudden deceleration determination permission flag to the MCU 72 via the CAN 100. That is, the ENG-HEV integrated CU 70 may serve as a gateway.

When receiving the sudden deceleration determination permission flag, in step S300, the MCU 72 may determine whether the engine speed is lower than or equal to a predetermined speed. If the engine speed is lower than or equal to the predetermined speed (step S300: Yes), the process may proceed to step S302. If the engine speed is not lower than or equal to the predetermined speed (step S300: No), the operation may once exit the process.

In step S302, a determination may be performed as to whether the motor speed is lower than or equal to a predetermined speed. If the motor speed is lower than or equal to the predetermined speed (step S302: Yes), the process may proceed to step S304. If the motor speed is not lower than or equal to the predetermined speed (step S302: No), the operation may once exit the process.

In step S304, a determination may be performed as to whether the wheel speed is lower than or equal to a predetermined speed. If the wheel speed is lower than or equal to the predetermined speed (step S304: Yes), the process may proceed to step S306. If the wheel speed is not lower than or equal to the predetermined speed (step S304: No), the operation may once exit the process.

In step S306, a determination may be performed as to whether a decreasing rate of the motor speed is greater than a predetermined value, that is, whether the motor speed is suddenly decreasing. If the decreasing rate of the motor speed is greater than the predetermined value, that is, if the motor speed is suddenly decreasing (step S306: Yes), the process may proceed to step S308. If the decreasing rate of the motor speed is the predetermined value or smaller, that is, if the motor speed is not suddenly decreasing (step S306: No), the operation may once exit the process.

In step S308, the reduction of the output torque of the electric motor 40 may be performed. For example, the output torque of the electric motor 40 may be reduced to 0 Nm.

Thereafter, in step S310, a determination may be performed as to whether a predetermined period of time has elapsed since the start of the reduction of the torque of the electric motor 40 (to 0 Nm). The predetermined period of time may be, for example, 0.5 seconds. If the predetermined period of time has elapsed since the start of the reduction of the torque of the electric motor 40 (to 0 Nm) (step S310: Yes), the process may proceed to step S312. If the predetermined period of time has not yet elapsed (step S310: No), the process in step S310 may be repeatedly executed until the predetermined period of time elapses.

In step S312, the reduction of the torque of the electric motor 40 may be stopped, that is, the operation may return to the normal control. Thereafter, the operation may once exit the process.

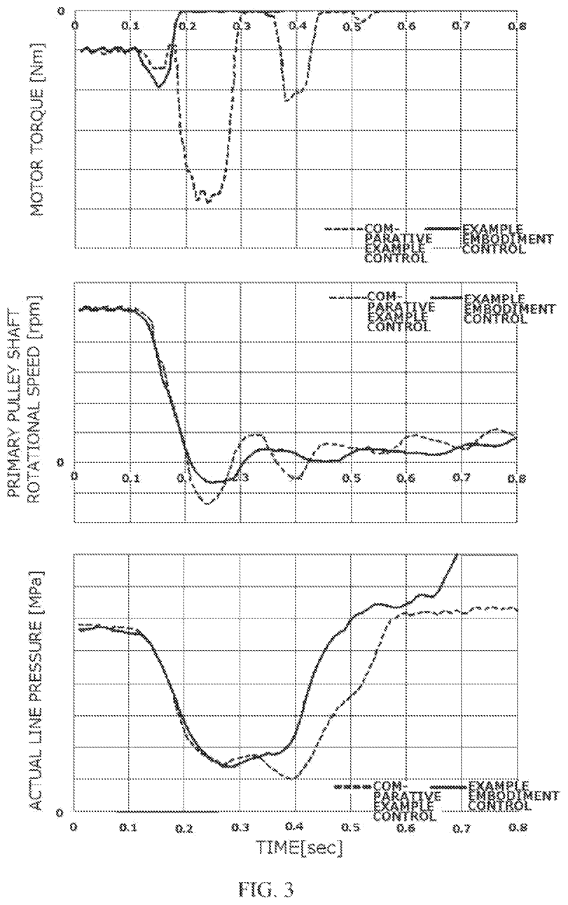

Next, example effects of the above-described sudden deceleration chain slip prevention control will be described with reference to FIG. 3. FIG. 3 includes timing charts illustrating respective examples of changes in motor torque, primary pulley shaft rotational speed, and actual line pressure (oil pressure) at the time of sudden deceleration during the EV traveling caused by each of the control system 1 for a hybrid vehicle and a control system (an existing control system) for a hybrid vehicle according to a comparative example.

In FIG. 3, horizontal axes represent time, and vertical axes represent the motor torque (Nm), the primary pulley shaft rotational speed (≈an oil pump rotational speed) (rpm), and the actual line pressure (MPa) in order from the top. In FIG. 3, respective waveforms related to the control system 1 for a hybrid vehicle according to the example embodiment are represented by solid lines. Respective waveforms related to the control system (the existing control system) for a hybrid vehicle according to the comparative example are represented by broken lines. The control system (the existing control system) for a hybrid vehicle according to the comparative example may be, for example, a control system in which a TCU performs a sudden deceleration determination with use of a vehicle speed, and if occurrence of sudden deceleration is determined, the TCU requests or instructs that an ENG-HEV integrated CU and an MCU perform reduction of motor torque (to 0 Nm).

As illustrated by the broken lines in FIG. 3, in the control system (the existing control system) according to the comparative example, the electric motor 40 continued to output negative torque also after the primary pulley shaft rotational speed dropped sharply at the time of sudden deceleration. As a result, the line pressure dropped greatly, and recovery was delayed. That is, the negative torque of the electric motor 40 influenced the oil pump rotational speed, and a discharge amount was decreased. In further detail, the motor torque was not able to be maintained at 0 Nm (negative torque was generated), and the primary pulley shaft rotational speed dropped greatly (down to −230 rpm). This caused the line pressure (the oil pressure) to drop greatly (down to 0.2 MPa).

In contrast, the following was confirmable regarding the control system 1 for a hybrid vehicle according to the example embodiment. That is, at the time of sudden deceleration, the motor torque was swiftly set to 0 Nm. This suppressed a decrease in the primary pulley shaft rotational speed, and allowed for faster recovery of the line pressure. In further detail, the following was confirmable. That is, the motor torque was maintained at 0 Nm (no negative torque was generated), and the drop of the primary pulley shaft rotational speed was suppressed to a smaller drop (down to −100 rpm). This reduced the drop of the line pressure (the oil pressure) (down to 0.3 MPa).

As described above in detail, according to the example embodiment, the TCU 74 may send or transmit the sudden deceleration determination permission flag when the predetermined permission condition is satisfied at the time of the EV traveling in which the engine 10 is stopped, the forward clutch 32 and the reverse brake 33 are disengaged, and the hybrid vehicle is driven simply by the electric motor 40. When receiving the sudden deceleration determination permission flag, the MCU 72 may perform the sudden deceleration determination of the vehicle. When determining occurrence of the sudden deceleration, the MCU 72 may perform the reduction of the output torque of the electric motor 40. For example, the MCU 72 may reduce the output torque of the electric motor 40 to 0 Nm. That is, the MCU 72 performing the sudden deceleration determination when the predetermined permission condition is satisfied makes it possible to reduce or resolve, for example, a delay in communication via the CAN 100, for example, as compared with a case where the TCU 74 performs the sudden deceleration determination, the TCU 74 requests the ENG-HEV integrated CU 70 to reduce the motor torque via the CAN 100, and the ENG-HEV integrated CU 70 instructs the MCU 72 to reduce the motor torque. It is also possible to prevent intervention of the ENG-HEV integrated CU 70 in the control. When the oil pump rotational speed decreases due to sudden deceleration (sudden braking) and the line pressure can possibly decrease, that is, when the chain can possibly slip, the output torque of the electric motor 40 may be swiftly reduced. This makes it possible to prevent the slip of the chain. As a result, it is possible to more reliably prevent the slip of the chain 54 (the driving force transmission member) of the continuously variable transmission 50 (the variator), when the hybrid vehicle suddenly decelerates at the time of the EV traveling in which the engine 10 is stopped, the forward clutch 32 and the reverse brake 33 are disengaged, and the hybrid vehicle is driven simply by the electric motor 40.

Further, according to the example embodiment, the MCU 72 may have the processing cycle (the calculation cycle) of the sudden deceleration determination of the vehicle shorter than that of the TCU 74, and such an MCU 72 may perform the sudden deceleration determination. This makes it possible to reduce a delay in processing. This also makes it possible to improve determination accuracy of the sudden deceleration determination.

Further, according to the example embodiment, the resolver 82 may be coupled to the MCU 72. The resolver 82 may have higher resolution than the vehicle speed sensor and may have a shorter sensing cycle than the vehicle speed sensor. The vehicle speed sensor may be, for example, the magnetic pickup. The MCU 72 may perform the sudden deceleration determination of the hybrid vehicle with use of a value detected by the resolver 82. This makes it possible to reduce a delay in sensing, and also makes it possible to improve the determination accuracy of the sudden deceleration determination.

According to the example embodiment, when the sudden deceleration determination permission flag is sent or transmitted from the TCU 74, the ENG-HEV integrated CU 70 may relay the sudden deceleration determination permission flag to the MCU 72. That is, the ENG-HEV integrated CU 70 may serve as a gateway. This makes it possible to reliably reduce the motor torque without the intervention of the ENG-HEV integrated CU 70 in the control. This also allows the ENG-HEV integrated CU 70 to recognize that the sudden deceleration determination and the chain slip prevention control is to be executed by the MCU 72.

According to the example embodiment, when the predetermined period of time (e.g., 0.5 sec) elapses after the reduction of the torque of the electric motor 40 (to 0 Nm) is started, the MCU 72 may stop the reduction of the torque of the electric motor 40. This makes it possible to appropriately stop the reduction of the torque of the electric motor 40, taking into consideration, for example, the period of time from the timing at which the engine 10 is restarted to the timing at which the oil pump 35 is driven by the engine 10.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof. For example, in the above-described example embodiment, the electric motor 40 may be coupled to the primary shaft 51 of the continuously variable transmission 50; however, a position to couple the electric motor 40 may be downstream of the secondary pulley 53 of the continuously variable transmission 50.

In the above-described example embodiment, the CAN 100 may be used as the communication line; however, the communication line is not limited to a CAN. In the above-described example embodiment, a hydraulic clutch may be used as each of the forward clutch 32, the reverse brake 33, the transfer clutch 64, and the output clutch 61; however, an electromagnetic clutch may be used, for example.

In the above-described example embodiment, an embodiment of the disclosure may be applied to the continuously variable transmission 50 of a chain type; however, an embodiment of the disclosure may also be applied to, for example, a continuously variable transmission of a belt type or any other type instead of the continuously variable transmission 50 of the chain type.

In the above-described example embodiment, the ENG-HEV integrated CU 70 may include integrated hardware; however, the ENG-HEV integrated CU 70 may include separated pieces of hardware. That is, the ENG-HEV integrated CU 70 may have a configuration in which an ECU controlling the engine 10 and an HEVCU generally controlling the hybrid vehicle may be provided separately from each other.

In one example configuration, the VDCU76 may be omitted.

Each of the ENG-HEV integrated CU 70, the MCU 72, the TCU 74, and the VDCU 76 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of each of the ENG-HEV integrated CU 70, the MCU 72, the TCU 74, and the VDCU 76 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of each of the ENG-HEV integrated CU 70, the MCU 72, the TCU 74, and the VDCU 76 illustrated in FIG. 1.

1. A hybrid vehicle control system configured to perform a control of a hybrid vehicle comprising an engine, an electric motor, a driving wheel, a clutch, and a continuously variable transmission, the hybrid vehicle control system comprising:
a transmission control unit configured to control the continuously variable transmission, the continuously variable transmission comprising a primary pulley, a secondary pulley, and a driving force transmission member, the primary pulley being coupled to each of the engine and the electric motor to allow for torque transmission between the primary pulley and each of the engine and the electric motor, the secondary pulley being coupled to the driving wheel to allow for torque transmission between the secondary pulley and the driving wheel, the driving force transmission member being wrapped around between the primary pulley and the secondary pulley;
a motor control unit configured to control the electric motor; and
an engine and hybrid vehicle integrated control unit communicably coupled to each of the transmission control unit and the motor control unit via a communication network, and configured to comprehensively control the engine and the hybrid vehicle, wherein
the transmission control unit is configured to send sudden deceleration determination permission information when a predetermined permission condition is satisfied at a time of electric vehicle traveling in which the engine is stopped, the clutch is disengaged, and the hybrid vehicle is driven by the electric motor, the clutch being interposed between the engine and the continuously variable transmission, and
the motor control unit is configured to perform a sudden deceleration determination of the hybrid vehicle when receiving the sudden deceleration determination permission information, and is configured to perform reduction of output torque of the electric motor when determining occurrence of sudden deceleration.

2. The hybrid vehicle control system according to claim 1, wherein the motor control unit has a processing cycle shorter than a processing cycle of the transmission control unit.

3. The hybrid vehicle control system according to claim 2, wherein
a motor speed sensor is coupled to the motor control unit, the motor speed sensor having higher resolution than a vehicle speed sensor and having a shorter sensing cycle than the vehicle speed sensor, the vehicle speed sensor being configured to detect a speed of the hybrid vehicle, and
the motor control unit is configured to perform the sudden deceleration determination of the hybrid vehicle with use of a value detected by the motor speed sensor.

4. The hybrid vehicle control system according to claim 3, wherein the engine and hybrid vehicle integrated control unit is configured to, when the sudden deceleration determination permission information is sent, relay the sudden deceleration determination permission information to the motor control unit.

5. The hybrid vehicle control system according to claim 4, wherein the motor control unit is configured to, when a predetermined period of time elapses after the reduction of the output torque of the electric motor is started, stop the reduction of the output torque of the electric motor.

6. A hybrid vehicle control system configured to perform a control of a hybrid vehicle comprising an engine, an electric motor, a driving wheel, a clutch, and a continuously variable transmission, the hybrid vehicle control system comprising
circuitry configured to
control the continuously variable transmission, the continuously variable transmission comprising a primary pulley, a secondary pulley, and a driving force transmission member, the primary pulley being coupled to each of the engine and the electric motor to allow for torque transmission between the primary pulley and each of the engine and the electric motor, the secondary pulley being coupled to the driving wheel to allow for torque transmission between the secondary pulley and the driving wheel, the driving force transmission member being wrapped around between the primary pulley and the secondary pulley,
control the electric motor, and
comprehensively control the engine and the hybrid vehicle, wherein
the circuitry is configured to
send sudden deceleration determination permission information when a predetermined permission condition is satisfied at a time of electric vehicle traveling in which the engine is stopped, the clutch is disengaged, and the hybrid vehicle is driven by the electric motor, the clutch being interposed between the engine and the continuously variable transmission, and
perform a sudden deceleration determination of the hybrid vehicle when receiving the sudden deceleration determination permission information, and perform reduction of output torque of the electric motor when determining occurrence of sudden deceleration.
